(19) United States
(12) Patent Application Publication
(10) Pub. No.: US 2026/0341542 A1
(43) Pub. Date: Oct. 29, 2026

(54) MULTIPART TRANSPORTABLE NUCLEAR POWER PLANT

(71) Applicant: Energie propre Prodigy Ltee / Prodigy Clean Energy Ltd., Montreal (CA)

(72) Inventors: Robert Rudolf STRIJLAND, Carreço (PT); Mathias TROJER, Brookline, MA (US)

(21) Appl. No.: 19/117,144

(22) PCT Filed: Sep. 29, 2023
(86) PCT No.: PCT/US2023/034151

§ 371 Date: Mar. 31, 2025

Related U.S. Application Data
(60) Provisional application No. 63/411,994, filed on Sep. 30, 2022.

(51) Int. Cl. G21C 1/32; G21D 1/02

(52) U.S. Cl. CPC G21C 1/32; G21D 1/02

(57) ABSTRACT

A multipart, transportable nuclear power plant includes a first barge with a containment. The first barge is transportable across a body of water to a dedicated site. The multipart, transportable nuclear power plant also includes at least one nuclear reactor disposed within the containment, at least one cooling element connected to the at least one nuclear reactor, and at least one electrical generator connected to the at least one nuclear reactor. The at least one cooling element and the at least one electrical generator also are transportable across the body of water to the dedicated site together with the first barge.

### CROSS-REFERENCE TO RELATED APPLICATIONS

This application relies for priority on U.S. Provisional Patent Application Ser. No. 63/411,994, entitled “MULTIPART TRANSPORTABLE NUCLEAR POWER PLANT,” filed Sep. 30, 2022, the content of which is hereby incorporated by reference in its entirety.

### FIELD OF THE INVENTION

The present invention relates to coastal deployment of small modular reactors (SMRs).

### BACKGROUND

The global need for energy sources that are sustainable, safe, economically viable, produce low or no carbon emissions, and have high energy density and high capacity factor is growing rapidly. Various novel nuclear reactor and power-plant designs, including some that incorporate small modular reactors (SMRs, defined as reactors for civil power generation producing <300 MWe), can meet this requirement while overcoming the drawbacks of conventional, terrestrial nuclear power plants. It is desirable that novel plant designs minimize development footprint (e.g., near coastal population centers) and are transportable/flexible in deployment. Moreover, to be secure and sustainable, novel designs must be robust against potential impacts of climate change, including sea level rise and dwindling supplies of freshwater for cooling. They should be robust against mechanical failures, malicious attack, human error, and natural disasters, including seismic events and tsunamis. They should avoid the high costs and decadal construction times that have persistently plagued large, one-off nuclear plants; site-specific design, approval, and construction processes entail high construction costs and long project durations that make conventional nuclear power projects expensive to finance and insure.

Coastal deployments of prefabricated, transportable nuclear power plants can address the foregoing needs. Such deployments can minimize development footprint and benefit from marine delivery of large components that must otherwise be built on-site. However, novel deployment schemes typically confront lengthy licensing delays. While certain SMR designs may receive design certification from various regulators (e.g., the NuScale™ Power Module SMR, a 77-MWe convection-cooled, light-water reactor, received design certification from the US Nuclear Regulatory Commission in 2020), such certification does not constitute authorization to actually construct such reactors, nor to deploy them in arbitrary configurations, combinations, siting arrangements, or the like. In the illustrative case of the NuScale Power Module, separate certification was required for the SMR design itself and for a “standard plant design” (nuclear island design) which incorporates up to a dozen NuScale Power Modules into a single building comprising a water pool in which the reactors are immersed and other specific features. The certification process for alternative standard plant designs, like that for the original standard plant design, takes on the order of a decade. Thus, substantially novel deployment schemes for SMRs, as for other reactor types, can entail decadal delays due to approval procedures alone, even where designs for individual SMRs are already approved. These delays are disadvantageous to novel coastal and other deployments of SMRs.

A need thus exists for methods and systems that utilize already-approved designs for the design and construction of nuclear plants incorporating SMRs for coastal deployments while exploiting already-approved standard plant designs. Preferably such methods and systems will also exploit the potential of marine transport for rapid, flexible delivery of large systems; minimize site-specific bespoke engineering costs; and realize other advantages of coastal deployments.

### SUMMARY OF THE INVENTION

The following summary is not intended to limit the scope of the present invention. Instead, the following summary provides an overview of various embodiments and constructions that are intended to be exemplary thereof.

Provided herein are methods, systems, components, and the like that enable multi-site centralized manufacturing, transporting, deploying, redeploying, fueling, and commissioning of a relocatable multipart nuclear power plant structure, herein termed a Multipart Transportable Nuclear Power Plant (MTNPP). In various embodiments the MTNPP comprises two or more vessels (e.g., barges) that comprise one or more small modular reactors (SMRs) and power-conversion, cooling, and other arrangements necessary to make the MTNPP, in essence, a standalone producer of electrical and/or thermal energy that is designed to be transported over large bodies of water such as oceans, large lakes, or rivers. An MTNPP, in various embodiments, preferably contains in one vessel various elements of an SMR-based nuclear island (e.g., control room, balance of plant systems, auxiliary systems, fuel-handling systems, waste-storage area, and an approved standard plant design (nuclear island/enclosure) comprising SMRs) and also contains in one or more additional vessels some or all additional elements of a nuclear power station (e.g., turbines, generators, cooling systems). Herein, a vessel containing SMRs is termed a “reactor barge” and a vessel containing other elements of a nuclear power station is termed an “ancillary barge.” An MTNPP comprises at least one reactor barge and at least one ancillary barge. Roughly speaking, and as shall be clarified with reference to the Figures hereinbelow, a reactor barge of an MTNPP comprises apparatuses typically found in the nuclear island portion of a traditional nuclear plant, and the ancillary barges of an MTNPP comprise apparatuses typically found in the conventional (a.k.a. turbine) island of a traditional nuclear plant. Moreover, both reactor barges and ancillary barges are in various embodiments preferably delivered overwater to and housed within a relatively shallow and sheltered natural or artificial harbor adjacent to an electrical grid or energy-consuming enterprise. The MTNPP is agnostic toward the specific design of the one or more SMRs comprised: that is, it can accommodate any of number of SMR designs or other reactor designs and nuclear island layouts, present and future, although preferably an already-approved standard plant design is comprised by an MTNPP reactor barge.

Herein, the terms “nuclear enclosure” and “nuclear island” are used interchangeably to signify a self-contained structure or substructure that houses SMRs and various apparatuses pertaining to the operation, cooling, fueling, and handling of SMRs. The nuclear island of the reactor barge of an MTNPP produces steam that is circulated to the ancillary barges, where power is generated and heat is dissipated from turbine-loop condensers. Herein also, although the term “SMR” is employed, there is no restriction to any particular reactor design or type, fission or fusion, or other variations found in present or future nuclear heat generators.

Preferably, standardized steam, electrical, and control interfaces connect the nuclear island of a reactor barge of the MTNPP to the other systems of the MTNPP, both on the reactor barge and on the one or more ancillary barges. The nuclear enclosure is thus a “black box” within the MTNPP that produces steam which is converted to electrical power by standard systems and which may also provide heat for direct applications (heating, industrial process heat, etc.). The components of an MTNPP are preferably fabricated and assembled in one or more shipyards and transported overwater to a dedicated site comprised by a coastal facility. The site may provide for protection of the MTNPP from aircraft impacts, seismic events, and other challenges. The balance of the coastal facility typically includes one or more switchyards, administrative buildings, connections to a standard grid or microgrid, energy storage devices, and other components pertaining to energy transformation, storage, and distribution. In some embodiments, power conversion occurs in the balance of the coastal facility rather than in the one or more ancillary barges of the MTNPP. Reactors may be installed (unfueled) on MTNPP reactor barges before transport to the coastal facility, or after. Preferably, SMRs housing active fuel loads are comprised by MTNPP reactor barges being transported to a coastal facility. An MTNPP reactor barge preferably comprises provisions for exchanging reactors and fresh and spent nuclear fuel between one or more land-or sea-based delivery systems and the interior of the barge's nuclear enclosure.

The MTNPP is preferably a complete facility capable of operating in a sheltered marine environment; integrates the safety, security and operational measures necessary to support its nuclear reactor and power conversion systems; and is specifically designed to be geographically relocated in a secure and controlled manner.

Herein, an MTNPP should be interpreted to mean a complete facility (land-or marine-based) integrating one or more nuclear reactors and power conversion system(s) and specifically designed to be geographically relocated. MTNPPs may offer periodic on-site refueling or use permanently fueled and sealed SMRs, depending on the reactor technology employed and how long the facility is intended to be in operation. Various MTNPPs can be designed to produce power over a wide range of outputs, as for example from a few megawatts to gigawatts, and can be used to deploy nuclear energy in locations where a traditionally constructed, fixed, land-based nuclear power plant is not technically or economically practical.

Various embodiments of the invention realize a number of advantages over the prior art for creating nuclear power stations. These include shipyard fabrication of the MTNPP reactor barge and ancillary barges, which enables faster construction and lower capital expenditure than one-off, on-site, terrestrial construction; turnkey delivery of one or more MTNPPs to a coastal facility; flexible overwater transport from the MTNPP site or sites of manufacture to the coastal facility; redeployability of the MTNPP (e.g., to another coastal facility), with attendant flexibility of business construct (e.g., short-or long-term leasing); portability of MTNPP components at end-of-lifetime to a dedicated maritime decommissioning yard for cost-effective decommissioning; ability to increase or decrease the power generating capacity of an existing MTNPP facility, within limits, by adding SMRs to or removing SMRs from a reactor barge and adding or removing ancillary barges to accommodate the increased or decreased steam output of the reactor barge; ability to increase or decrease the power generating capacity of an existing MTNPP facility, within limits, by adding or removing reactor barges and ancillary barges to an existing MTNPP facility; ability to locate the MTNPP anywhere in the world that is accessible by overwater transport, given sufficient depth for barge delivery and the availability of a suitable natural, modified, or artificial harbor, regardless of availability of terrestrial infrastructure (e.g., roads); and at some sites (e.g., ocean-adjacent sites) access to an effectively unlimited supply of cooling water, in contrast to conventional terrestrial nuclear plants that may be forced to cease operation when drought reduces cooling water supplies. An additional advantage realized by various embodiments is that a reactor barge of an MTNPP can be constructed in one shipyard (e.g., one in a nation with which there are no restrictions on sharing nuclear technology) while an ancillary barge of an MTNPP can be constructed in another shipyard (e.g., one in a nation with which conventional power-conversion and cooling technologies, but not nuclear technologies, can be shared). Non-security-related economic considerations may also influence the choice of shipyards for reactor and ancillary barge construction, as for example if economies can be realized by having one shipyard specialize in the construction of reactor barges and another shipyard specialize in the construction of ancillary barges. Also advantageously, the prepared site of a MTNPP is in various embodiments relatively simple, consisting primarily of a pool or lagoon adjacent to a navigable body of water but sheltered from untoward water-level fluctuations, storm waves, tsunamis, unauthorized entrance, and other disturbances.

It is, therefore, one aspect of the present invention to provide a multipart, transportable nuclear power plant that includes a first barge with a containment, where the first barge is transportable across a body of water to a dedicated site, at least one nuclear reactor disposed within the containment, at least one cooling element connected to the at least one nuclear reactor, the at least one cooling element also being transportable across the body of water to the dedicated site together with the first barge, and at least one electrical generator connected to the at least one nuclear reactor, the at least one electrical generator also being transportable across the body of water to the dedicated site together with the first barge.

In one contemplated embodiment, the at least one cooling element also is disposed on the first barge.

In another contemplated embodiment, the at least one electrical generator also is disposed on the first barge.

Still further, the multipart, transportable nuclear power plant may include a first ancillary barge connected to the first barge, where the at least one electrical generator is disposed on the first ancillary barge.

In another embodiment, the multipart, transportable nuclear power plant may have a first ancillary barge connected to the first barge, where the at least one cooling element is disposed on the first ancillary barge.

It is also contemplated that the multipart, transportable nuclear power plant may have a second ancillary barge connected to the first barge, wherein the at least one electrical generator is disposed on the second ancillary barge.

In one contemplated configuration of the multipart, transportable nuclear power plant, the first barge includes a first hull and a second hull with a first space therebetween, where the first space receives a first ballast material to at least partially submerge the first barge.

Still further, the first ancillary barge may include a third hull and a fourth hull with a second space therebetween, where the second space receives a second ballast material to at least partially submerge the first ancillary barge.

Moreover, it is contemplated that the second ancillary barge may include a fifth hull and a sixth hull with a third space therebetween, where the third space receives a third ballast material to at least partially submerge the second ancillary barge.

In a further contemplated embodiment, the dedicated site is a lagoon separated from the body of water by a physical barrier that may or may not allow fluid communication between the lagoon and the body of water.

These and other distinguishing aspects of embodiments of the invention, along with various advantages of embodiments, will be clarified hereinbelow with reference to the Figures.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 depicts a standard SMR nuclear island design according to a design known in the prior art.

FIG. 2 depicts a terrestrial nuclear power plant comprising SMRs, with a construction known in the prior art.

FIG. 3A depicts a reactor barge comprising an SMR nuclear island.

FIG. 3B depicts the reactor barge of FIG. 3A in transverse cross section, taken along line 3B-3B in FIG. 3A.

FIG. 4A depicts a cross-section of a barge comprising power-conversion and cooling apparatus(es).

FIG. 4B depicts the barge illustrated in FIG. 4A, showing the barge in a partially ballasted condition.

FIG. 4C depicts the barge illustrated in FIG. 4A, showing the barge in a fully ballasted condition.

FIG. 5 depicts, in a vertical longitudinal cross-section, portions of an ancillary barge according to the present invention.

FIG. 6A depicts, in a top-down view, portions of one contemplated embodiment of a MTNPP installation.

FIG. 6B depicts the installation of FIG. 6A in a transverse cross section taken along line 6B-6B in FIG. 6A.

FIG. 6C depicts the installation illustrated in FIG. 6A, as a cross-section taken along the line 6C-6C in FIG. 6A.

FIG. 6D illustrates a variation of the installation shown in FIG. 6C, where the seabed includes a channel to accommodate the reactor barge of the MTNPP.

### DETAILED DESCRIPTION OF THE FIGURES

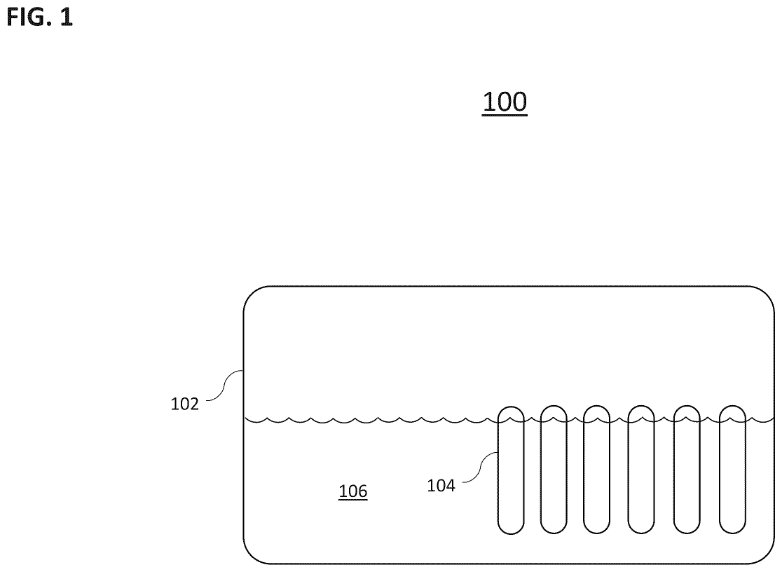

FIG. 1 schematically depicts in vertical, longitudinal cross-section portions of an illustrative standard SMR plant design or nuclear island 100 according to the prior art. Herein, “standard plant design” refers to a self-contained nuclear island or structure that has, preferably, been reviewed by a respected regulatory body (e.g., the US Nuclear Regulatory Commission, the Canadian Nuclear Safety Commission, the Western European Nuclear Regulators Association) and approved for deployment. The illustrative standard plant design depicted comprises a containment structure 102, a number of SMRs (e.g., SMR 104), and a water pool 106 in which the SMRs are immersed. Other components, such as fuel-handling apparatuses, a gate through which SMRs and other objects may enter and exit the containment 102, an upending device can rotate SMRs between horizontal and vertical positions, and an overhead crane that can move SMRs and other components about within the containment 102, are omitted from FIG. 1 for simplicity. The design of the island 100 comprises two parallel rows of six SMRs (e.g., NuScale Power Modules) for a total of 12 SMRs (only one row is depicted). When the nuclear island 100 is incorporated into a nuclear power plant, a steam loop (not depicted) transfers thermal energy from the SMRs within the island 100 to an external power-conversion system (not depicted) that generates electricity, as is typical for nuclear power plants. The pool 106 serves as a passive emergency heat sink: it is sized so that its heat of evaporation (enthalpy of vaporization) is sufficient, in case of an emergency shutdown with loss of active steam-loop flow, to dissipate enough of the heat contained within the individual cores of the SMRs to place the SMRs in a thermally safe condition.

The standard plant design 100 resembles the standard plant design for which NuScale Inc. received US regulatory approval. Herein, this standard plant design is used illustratively as an example of a standard plant design comprised by various embodiments of the invention, but no restriction is intended and other plant designs, either presently approved or in the process of being approved, are contemplated, e.g., plant designs incorporating the Rolls-Royce SMR, the Ge-HITACHI BWRX-300 SMR, the HOLTEC SMR-160, X-Energy's XE-100, or the Nuward SMR, among others. It is advantageous that an approved plant design, whether that of FIG. 1 or another, can be comprised by various embodiments without additional lengthy (e.g., decadal) delays for regulatory approval of a novel plant design. Various embodiments preferably incorporate nuclear islands that instantiate already-approved standard plant designs and thus promptly satisfy regulatory requirements.

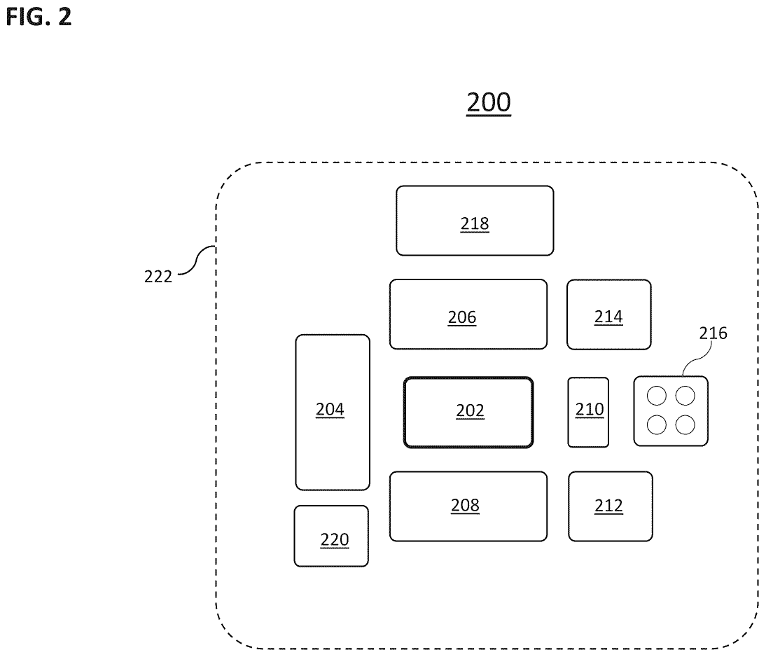

FIG. 2 depicts, in a schematic top-down view, portions of a terrestrial nuclear power plant 200 comprising a nuclear island 202 similar to nuclear island 100 of FIG. 1 according to the prior art. The plant 200 comprises a number of functional blocks in addition to the nuclear island 202, including one or multiple turbine-generator buildings 204, condenser-loop cooling structures 206, 208, administrative offices 210, a radioactive waste storage building 212, a control room structure 214, a dry-cask storage area 216, a switch yard 218, an annex building 220, and a security fence/outer plant perimeter defense systems 222.

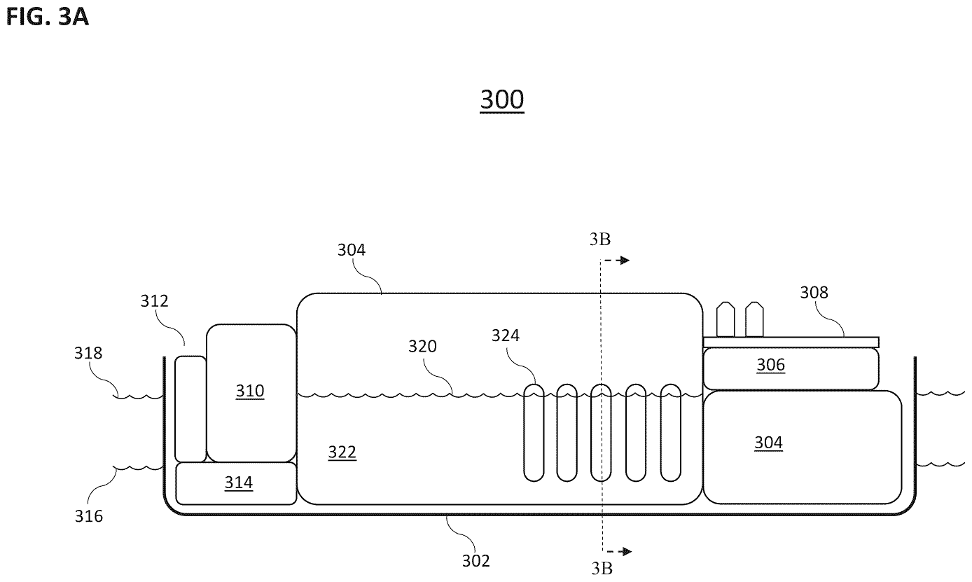

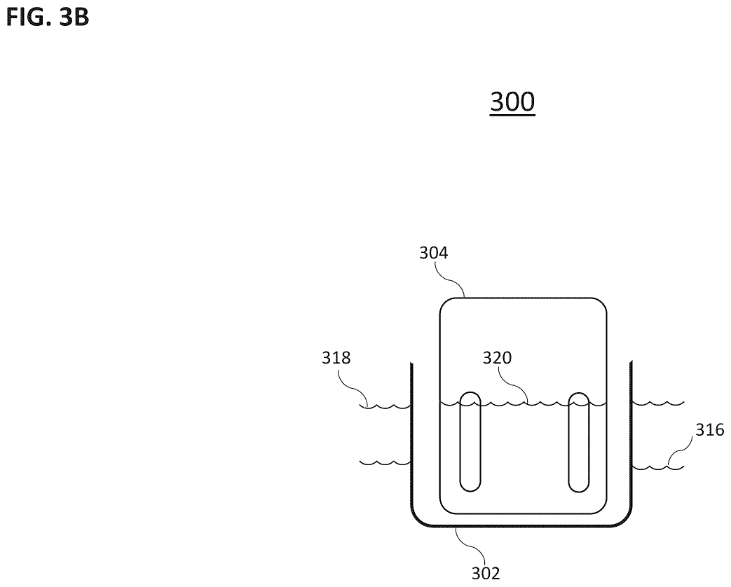

FIG. 3A depicts schematically in vertical longitudinal cross-section portions of an illustrative reactor barge 300 according to an embodiment of the invention. The barge 300 comprises a number of functional blocks corresponding approximately in capacity to some of those of the terrestrial plant 200 of FIG. 2, packaged within a hull 302 and supplemented by additional functional blocks. In particular, the barge 300 comprises a nuclear island 304 similar to the nuclear island 100 of FIG. 1, a radioactive waste structure 304, administrative offices 306, a dry-cask storage platform 308, a control room 310, a central utilities building 312, and an engine room and auxiliary generator room 314. Other components of the barge 300 (e.g., funnel, steam loop, cranes, ballasting system) are not depicted for simplicity.

The barge 300 is preferably fabricated in a shipyard and transported overwater, without active reactors/fuel onboard, to a dedicated site. When moved overwater, the barge 300 is preferably towed or is transported by a heavy-lift vessel.

The barge 300 has a natural (i.e., wholly or partly unballasted) draft at waterline 316 and can be ballasted down to a desired operating draft, e.g. higher waterline 318. During the transport process (e.g., from its place of manufacture to its coastal deployment site), the barge 300 is wholly or partly unballasted and floats at the level of the lower waterline 316. When installed at its coastal deployment site, the barge 300 is ballasted to the level of the higher waterline 318. When ballasted to the higher waterline 318, the barge 300 may either be grounded on a prepared seabed or float with a low under-keel clearance. Grounding may confer stability benefits against some probable and possible environmental conditions by physically prohibiting and/or limiting the degrees of freedom of movement of the barge 300. Allowing under-keel clearance, while not constraining pitch and roll motions as much as grounding, confers greater seismic isolation, since seismic waves or waves of acoustic energy are dampened by the body of water, which creates a discontinuous (solid-liquid-solid) interface between the Earth's crust and the hull 302 that does not significantly transmit shear forces. Additionally, for a floating barge 300 tidal variations are compensated by purposefully allowing vertical movement of the barge 300 in a controlled and predictable manner. In various embodiments, some of the advantages of both grounding and floating are realized by causing the barge 300 to rest upon seismic isolators (not depicted) installed in-between the keel/bottom of the barge and the prepared seabed.

The upper waterline 318 is approximately at the normal water level 320 of the emergency cooling pool 322 comprised by the nuclear island 304, that is, at a level at or above the tops of the SMRs (e.g., SMR 324): waters surrounding the barge 300 at its deployment site thus afford the SMRs within it a degree of protection from low-angle aircraft impacts.

FIG. 3B depicts in schematic transverse cross-section the barge 300 at the broken line 3B-3B of FIG. 3A. The hull 302, nuclear island 304, and two of the twelve SMRs are depicted. The approximate alignment of the normal water level 320 of the cooling pool 322 with the upper water level 318 is apparent.

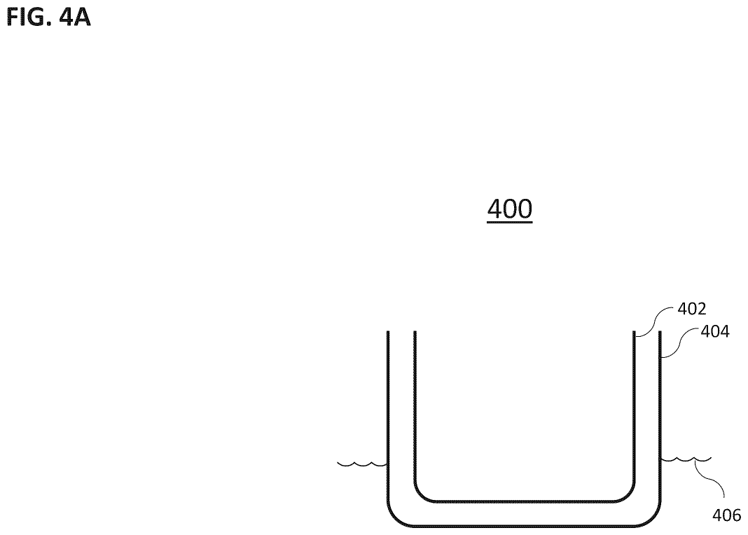

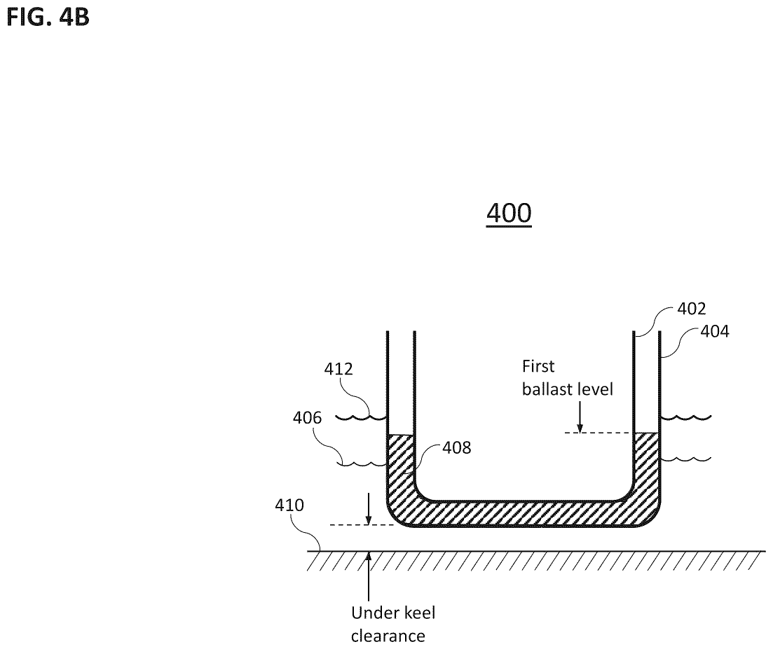

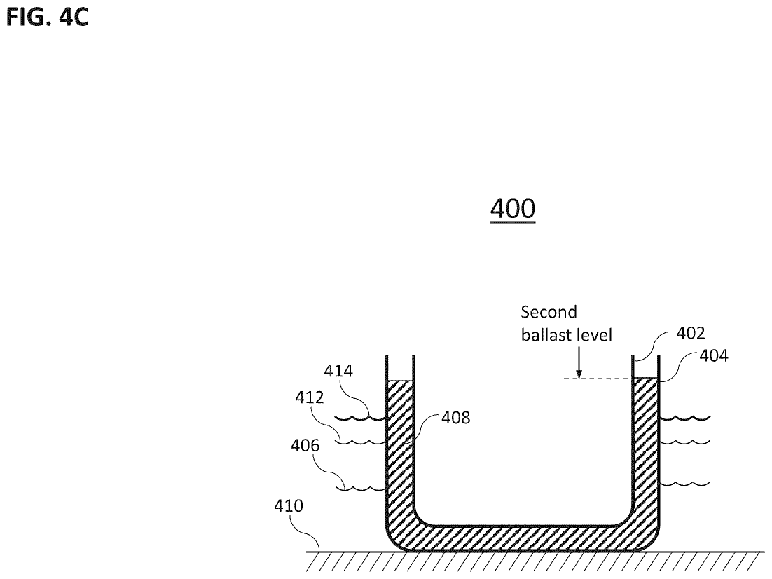

Ballasting down a reactor barge (e.g., barge 300) presents the challenge that, depending on the size and weight of the barge, a large mass of water must be displaced. Various embodiments address this need by comprising a double hull capable of holding ballast, as depicted in FIGS. 4A, 4B, and 4C.

FIG. 4A depicts in schematic transverse cross-section a reactor barge 400 according to an illustrative embodiment of the invention. The nuclear island of the reactor barge 400 is omitted from FIG. 4A for simplicity. Barge 400 is similar to barge 300 of FIG. 3A but comprises a double hull, i.e. inner hull 402 and outer hull 404. In the partly or wholly unballasted condition of operation depicted in FIG. 4, the space between the hulls 402, 404 is filled primarily with air and the barge 400 is floating at a low waterline 406 similar to lower waterline 316 of FIG. 3A. Preferably the barge 400 is transported overwater via a heavy lift vessel and/or via wet tow in the partly or wholly unballasted condition depicted in FIG. 4A.

FIG. 4B depicts the reactor barge 400 in a first, partly ballasted condition. In this condition, the space between the hulls 402, 404 is filled to a first ballast level with a ballasting material 408. The ballasting material 408 is in various embodiments a liquid, a slurry or mixture of solid particles and liquid, or a mass of solid granules. In various embodiments the ballasting material is of high density relative to water and is a relatively good radiation shield. In the embodiment of FIG. 4B, the ballasting material 408 consists of granulated lead, which is dense and low-cost and has excellent shielding properties. Advantageously, a liquid, slurry, or granulated material can be poured into the space between the hulls 402, 404 to ballast the barge 400 and pumped or suctioned out to unballast the barge 400. In the case of a slurry or granulated material, injected liquid or gas may be injected between the hulls 402, 404 to fluidize settled solids to enable pumping or suctioning.

In the condition of operation depicted in FIG. 4B, the barge 400 has been ballasted down at an operational location above a seabed 410, preferably that of an installation site, leaving a nonzero under keel clearance. The waterline 412 of the barge 400 is higher than that of the preferred transport waterline 406.

FIG. 4C depicts the barge 400 of FIG. 4A in a second, fully ballasted condition. In the condition of FIG. 4C, the space between the hulls 402, 404 is filled to a second ballast level with the ballasting material 408 (in this example, granulated lead). The higher ballast level of this condition causes the barge 400 to be grounded on the seabed 410, with a waterline 414 that is higher than the waterline 412 of FIG. 4B or the waterline 406 of FIG. 4A.

In both the condition shown in FIG. 4B and in the condition shown in FIG. 4C, it is preferable that the waterline of the barge 400 be level with or above the waterline within the nuclear island comprised by the barge 400 (e.g., the waterline 320 depicted in FIG. 3A), so that the waters surrounding the barge 400 may provide a degree of protection from low-angle aircraft impacts. In various embodiments where there is no water pool within the nuclear island, it is preferable that the installed waterline be at a level that is at or above the topmost portion of any SMR comprised by the nuclear island.

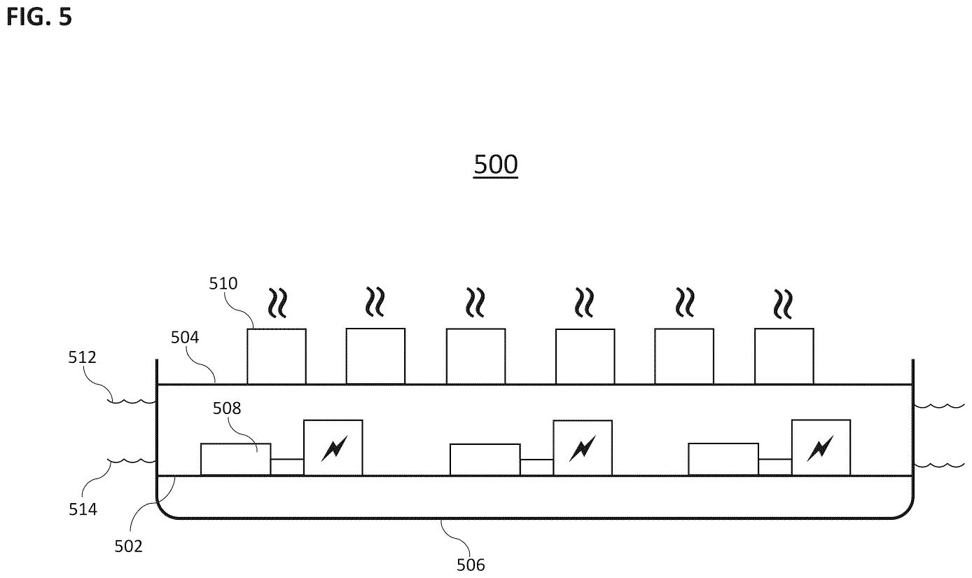

FIG. 5 depicts schematically in vertical longitudinal cross-section portions of an illustrative ancillary barge 500 according to an embodiment of the invention. The barge 500 comprises two major functional blocks corresponding approximately in capacity to two of those of the terrestrial plant 200 of FIG. 2. In particular, the barge 500 comprises a turbine-generator deck 502 and a cooling deck 504, both packaged within a hull 506. The apparatuses of the barge 500 are similar in nature, capacity, and overall size to those of the corresponding blocks 204, 206, 208 of conventional nuclear plant 200 of FIG. 2, including a portion of a primary loop (not depicted) that conveys steam to and from the nuclear island 304 of FIG. 3A, and a secondary steam loop (not depicted) heated by the primary loop via a heat exchanger (not depicted). Steam in the secondary loop drives turbine-generator sets (e.g., turbine-generator set 508 or other electrical generator) on the turbine-generator deck 502. The cooling deck 504 comprises nonevaporative condensers (e.g., condenser 510 or other cooling element) that condense coolant in the secondary loop. Various other components of the barge 500 (e.g., electric power lines, ballasting systems) are not depicted for simplicity.

The barge 500 is preferably fabricated in a shipyard and transported overwater to a dedicated coastal site. When moved overwater, the barge 500 is preferably towed or is transported by a heavy-lift vessel. The barge 500 can accommodate ballasting to at least two waterlines, an upper waterline 512 and a lower waterline 514. During transport process (e.g., from its place of manufacture to its coastal deployment site), the barge 500 own draft is at the lower waterline 514. When installed at its coastal deployment site, the barge 500 operating draft may be approximately at waterline 514 and/or may be ballasted down to 512, depending on operating requirements. The barge 500 may either be grounded on a prepared seabed or be deployed as a floating structure with under-keel clearance.

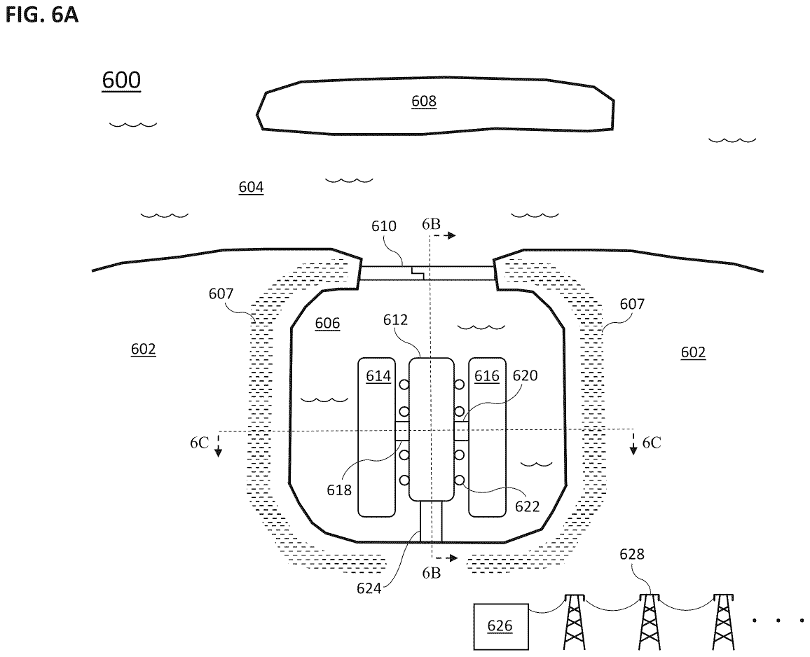

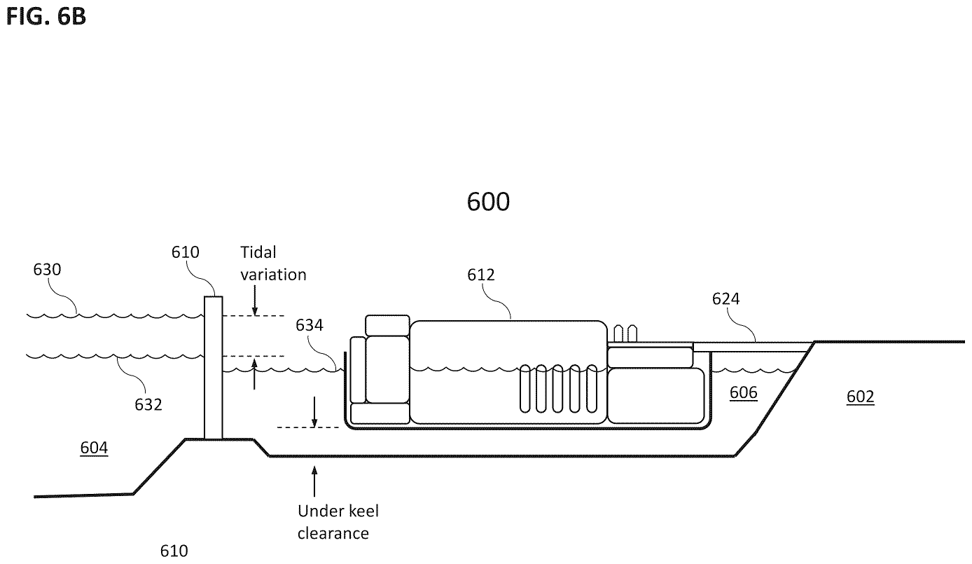

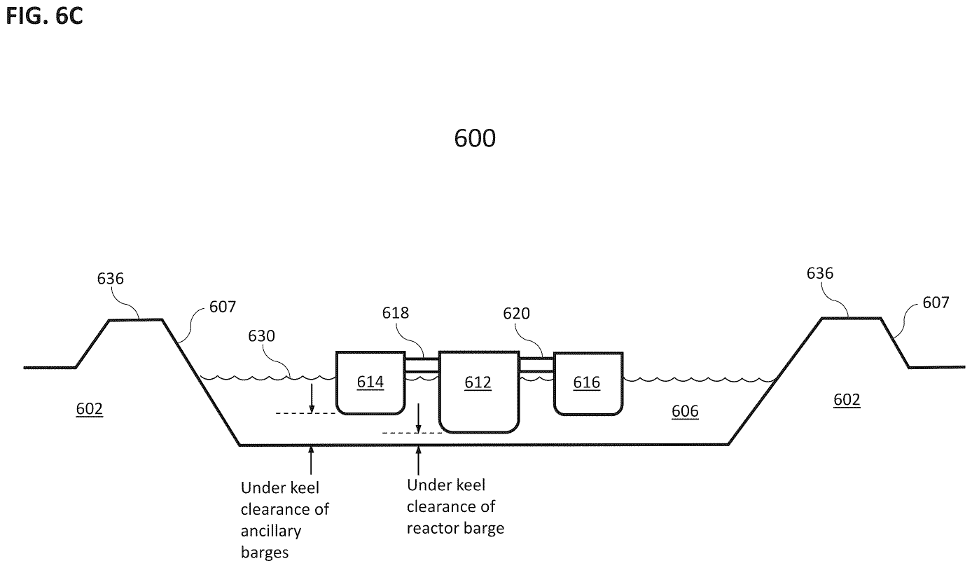

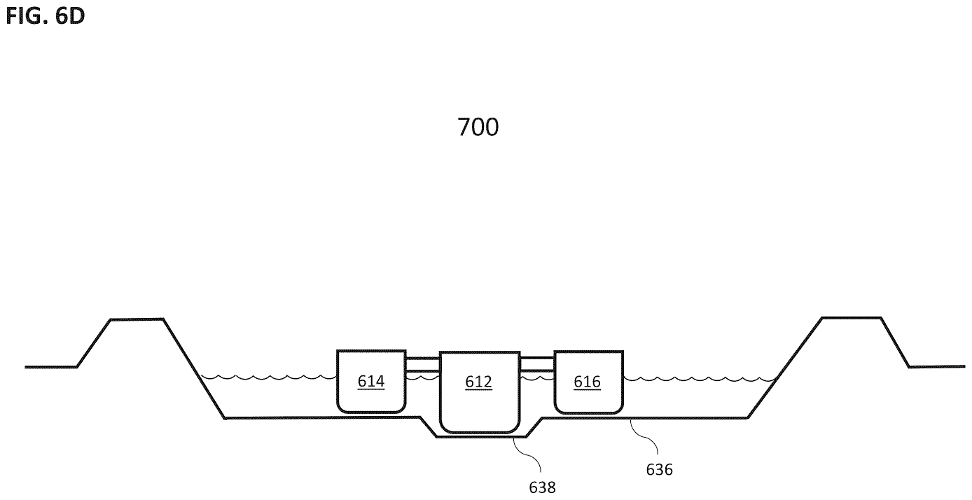

FIG. 6A schematically depicts in top-down view portions of an illustrative coastal MTNPP installation 600. The installation 600 is preferably adjacent to an existing industrial port area or other location where power can be delivered to a grid or other recipients, e.g., facilities for clean (H2) and/or low-carbon and synthetic fuels, etc.. The installation 600 is set into a landmass 602 bounding a water body 604 that is navigable by MTNPP barges. A pool or lagoon 606 has been dredged and/or excavated in the landmass 602, and a breakwater 608 reduces wave action at the entrance to the lagoon 606. The entrance to the lagoon 606 is blocked by an openable or removable barrier or gate 610 that prevents waves and/or unauthorized vessels from entering the lagoon 606. In various embodiments, the barrier 610 is watertight and can thus preserve the water within the lagoon 606 at a constant level at or above that of the water body 604. A berm 607, built from material dredged to form the lagoon 606, partially surrounds the lagoon 606. Preferably, the berm 607 is constructed of material dredged to create the lagoon 606. Together, the barrier 610 and berm 607 are designed to exclude water incursions foreseeable from storm surge, sea-level rise, and/or tsunami within a locally and legally suitable time window (e.g., 200 years). The gate 610 and berm 607 are preferably engineered to keep the lagoon water level 630 approximately constant even under conditions such as hurricane storm surges, tsunamis, and sea-level rise.

The barrier 610 also constitutes a portion of a security barrier (not depicted) that surrounds the MTNPP lagoon 606 and adjacent facilities. Moreover, the berm 607 serves as partial protection of the reactor barge 612 from aircraft impacts by constraining approaching aircraft to steeper angles of attack, which make an aircraft more difficult to direct to a target. The water in the lagoon 606 also partially shelters the reactor barge 612 and the SMRs within it from aircraft impacts.

An MTNPP reactor barge 612 (also referred to as a first barge and as a primary barge 612) and two ancillary barges 614, 616 are installed within the lagoon 606. Together, these three barges 612, 614, 616 and the structures connecting them to each other and to the landmass 602 constitute the illustrative MTNPP. The reactor barge 612 is connected by two utility bridges 618, 620 to the ancillary barges 614, 616. The utility bridges 618, 620 support steam, electrical, communication, pedestrian, vehicular, and other connections between the barges. Preferably, in various embodiments the bridges 618, 620 can accommodate a degree of flexure, enabling some independent movement of the barges thus connected, as for example if water movements or seismic shocks move one or more of the barges. In various embodiments the bridges 618, 620 and communicative structures they support (e.g., steam lines) can accommodate a relatively large degree of flexure; in various other embodiments, the bridges 618, 620 are rigid or relatively rigid, and effectively unite the three barges 612, 614, 616 into a single mechanical unit, constraining their relative yaw, pitch, and roll movements to within acceptable limits. In embodiments where the bridges 618, 620 are relatively rigid, the ancillary barges 614, 616 act as outriggers which, given that the resulting combined structure is either grounded or has under-clear clearance in the lagoon 606, constrain the pitch and roll movements of the reactor barge 612 in the event of large waves, tsunami, seismic shock, or the like, tending to keep the SMRs in the reactor barge 612 within their limits of acceptable deviation from the vertical. Pitch movements of the reactor barge 612 also tend to be constrained by the length of the barge 612 and its contact with or proximity to the level floor of the lagoon 606. If the barrier 610 and berm 607 maintain the lagoon water level 630 within design limits, the reactor barge 612 and its ancillary barges 614, 616 (FIG. 6A) will remain in place despite storm surges, tsunamis, and the like, either grounded on the floor of the lagoon 606 or with under-keel clearances that are within acceptable limits. Further, the ancillary barges 614, 616 surrounding the reactor barge 612 act as an additional physical protective buffer from aircraft impacts. Moreover, safe-breakaway mechanisms are in various embodiments incorporated into the bridges 618, 620 and the connections they support to minimize damage to the barges in case misalignment exceeds design limits.

In the illustrative embodiment of FIG. 6A, roll, yaw, and lateral horizontal movements of reactor barge 612 are also constrained by a number of pilings, e.g. piling 622, which are in contact with, or sufficiently close to, a fendering system, bumpers (not depicted) on the sides of the hull of the barge 612 to prevent rolling that would exceed the operating limits of its SMRs. Piling 622 and/or additional pilings (not shown) may further constrain horizonal and rotational movements of the reactor barge 612 and/or the ancillary barges 614, 616.

An access bridge 624 connects the nuclear barge 612 to the landmass 602. In this illustrative case, the access bridge 624 supports all physical interchanges of the MTNPP to landward facilities, including power lines, water lines, communications cables, pedestrian and vehicle traffic, and the like. Among the facilities on the landward side is an electrical interconnection facility (e.g., transformer station) 626 and power line 628 that enable the MTNPP to contribute power too and/or receive power from a grid that may (e.g., retrofitting a fossil fuel powered facility accessible by waterway with an MTNPP) or may not exist yet..

In the illustrative deployment of FIG. 6A, the MTNPP contains up to 12 SMRs, which produce sufficient heat to require two ancillary barges. In other operational states of this MTNPP, the reactor barge 612 comprises fewer SMRs. If 6 or fewer SMRs are comprised, the MTNPP comprises only one ancillary barge. The number is 12 illustrative only: other numbers of SMRs are accommodated by various embodiments. In various embodiments of the invention, a reactor barge may comprise any nonzero number of SMRs, and an MTNPP may comprise any nonzero number of reactor barges, ancillary barges, and utility bridges. To maximize the power output of an MTNPP, the generation and cooling capacities of its ancillary barges must be great enough to make use of the heat produced by its complement of SMRs, and will preferably be sized to do so.

FIG. 6B schematically depicts in transverse cross-section the MTNPP installation 600 at the broken line 6B-6B of FIG. 6A. Visible are the water body 604, the landmass 602, the lagoon 606, the gate 610, and the reactor barge 612, which is similar to the barge 300 of FIG. 3. The level of the water body 604 varies between two foreseeable extremes (e.g., highest and lowest tide), a high extreme 630 and a low extreme 632. In this illustrative operational state, the water level 634 of the lagoon 606 is lower than the low extreme 632 of the water body 604. The level of the water body 604 may vary due to tides, sea-level rise, storm surge, upstream rainfall variations, and other causes; preferably, the lagoon level 634 is held constant at a level at least no higher than the minimum ever achieved by the water body 604. If this condition is met, failure of the barrier 610 can only allow water into the lagoon 606, raising its level and floating the barge 612 to a higher level; it cannot allow water to exit the lagoon 606. Raising the lagoon 606 presents no hazard to the barge 612, whose nonvertical motions are constrained by pilings 622 as described with reference to FIG. 6A. On the contrary, if sufficient water were to exit the lagoon 606, the barge 612 might ground. If designed to float with a nonzero under keel clearance as depicted in FIG. 6B, a barge would not be damaged by grounding. The vertical scale of FIG. 6B is exaggerated for the depiction of water levels; landmass 602, depicted as lower than the high ocean extreme level 630, will in practice typically be at least as high as that extreme. Moreover, the berm 607 of FIG. 6A and the barrier 610 are preferably capable of preserving a constant lagoon level 634 even when the water body 604 temporarily transgresses, within limits, either its high extreme level 630 or low extreme level 632. The berm 607 of FIG. 6A is not visible in FIG. 6B because the broken line 6B-6B of FIG. 6A transects an opening in the berm 607 that allows passage to the access bridge 624.

FIG. 6C schematically depicts in transverse cross-section the MTNPP installation 600 at the broken line 6C-6C of FIG. 6A. Visible are the landmass 602, the lagoon 606, the reactor barge 612, the ancillary barges 614, 616, the utility bridges 618, 620, and the berm 607 largely surrounding the lagoon 606. In this illustrative embodiment, the ancillary barges 614, 616 have a significantly lower draft than the reactor barge 612. As a result, the ancillary barges 614, 616 can, except as constrained by the utility bridges 618, 620, move vertically with respect to the reactor barge 612, e.g. as forced by wave action. Therefore, in various embodiments where the ancillary barges 614, 616 have shallower draft than the reactor barge 612, the bridges 618, 620 are preferably designed either to maintain functional connections (e.g., of coolant loop lines) even under anticipated departures of the barges 612, 614, 616 from a common level, or to be rigid enough to prevent significant departure of the barges from alignment.

FIG. 6D schematically depicts in transverse cross-section an illustrative MTNPP installation 700 similar to that depicted in FIG. 6A and FIG. 6C, but with the difference that the lagoon floor 636 comprises a channel or notch 638 in which the reactor barge 612 is set. The difference in depth between the lagoon floor 636 and the floor of the channel floor 638 is approximately equal to the difference in draft between the reactor barge 612 and the ancillary barges 614, 616. All three barges may be floating and/or grounded. It will be clear that despite the difference in draft between the reactor barge 612 and the ancillary barges 614, 616, the three barges are less likely to depart from alignment due to wave action (for example tsunami wave washing over physical barriers such as breakwaters and berms surrounding the MTNPP) than are the three barges of FIG. 6C. The illustrative embodiment of FIG. 6D thus realizes some of the advantages of interconnecting the barges with rigid utility bridges, with the additional benefit that the grounded barges of FIG. 6D are less likely to depart not only from mutual alignment but from the horizontal than are the floating barges of FIG. 6C.

In general, it is advantageous that in various embodiments the reactor barge 612 has a different (typically deeper) draft than the ancillary barges 614, 616: unlike the reactor barge 612, the ancillary barges 614, 616 do not contain SMRs that may or may not have a significant vertical extension (e.g., 20+ meters) and which, for aircraft impact protection, are preferably installed below the lagoon waterline 630 as depicted in FIG. 6B. The ancillary barges 614, 616 therefore do not functionally require a draft as deep as that of the reactor barge 612, but functionally act as a protective buffer to 612. Further, if the ancillary barges 614, 616 have no nuclear safety related equipment and systems onboard, the ancillary barges 614, 616 can be constructed at any suitable shipyard facility without the need of e.g., an ASME “N-Stamp” Certification for Nuclear Components. Commercially this increases the number of shipyards at which the ancillary barges can be manufactured and simplifies the overall supply chain complexity.

In various embodiments, the reactor barge 612 comprises arrangements and apparatuses (not depicted) for adding and removing SMRs, for loading and unloading dry casks either empty or containing radioactive waste, and other purposes, including but not limited to arrangements and apparatuses already known to the prior art of nuclear power plant design and operation. Various schemes for fueling and refueling SMRs of an MTNPP are contemplated, including but not limited to on-site fueling and refueling within the nuclear island of the reactor barge 612 according to procedures pre-approved by regulatory bodies for the standard plant design instantiated by the nuclear island. Alternatively or additionally, SMRs requiring repair, refueling, or decommissioning may be removed from the MTNPP installation entirely, transported overland or overwater to a suitable facility, and there refueled, repaired, or decommissioned. An SMR removed from an MTNPP may be replaced with the same SMR or another SMR to maintain the power output of the MTNPP. All such arrangements and procedures, as well as variations thereon that will be readily apparent to one familiar with the art of nuclear power plant design and operation, are contemplated and within the scope of the invention.

The foregoing has been a detailed description of illustrative embodiments of the invention. Various modifications and additions can be made without departing from the spirit and scope of this invention. Each of the various embodiments described above may be combined with other embodiments in order to provide multiple features. Any of the abovementioned embodiments can be deployed on or along a natural or man-made coastline, or on a natural or artificial island, or on a floating or stationary marine platform, or underwater. Furthermore, while the foregoing describes a number of separate embodiments of the apparatus and method of the present invention, what has been described herein is merely illustrative of the application of the principles of the present invention. Accordingly, this description is meant to be taken only by way of example, and not to limit the scope of this invention.

What is claimed is:

1. A multipart, transportable nuclear power plant, comprising:
a first barge comprising containment, wherein the first barge is transportable across a body of water to a dedicated site;
at least one nuclear reactor disposed within the containment;
at least one cooling element connected to the at least one nuclear reactor, the at least one cooling element also being transportable across the body of water to the dedicated site together with the first barge; and
at least one electrical generator connected to the at least one nuclear reactor, the at least one electrical generator also being transportable across the body of water to the dedicated site together with the first barge.

2. The multipart, transportable nuclear power plant according to claim 1, wherein the at least one cooling element also is disposed on the first barge.

3. The multipart, transportable nuclear power plant according to claim 1, wherein the at least one electrical generator also is disposed on the first barge.

4. The multipart, transportable nuclear power plant according to claim 1, further comprising:
a first ancillary barge connected to the first barge, wherein the at least one electrical generator is disposed on the first ancillary barge.

5. The multipart, transportable nuclear power plant according to claim 1, further comprising:
a first ancillary barge connected to the first barge, wherein the at least one cooling element is disposed on the first ancillary barge.

6. The multipart, transportable nuclear power plant according to claim 4, further comprising:
a second ancillary barge connected to the first barge, wherein the at least one electrical generator is disposed on the second ancillary barge.

7. The multipart, transportable nuclear power plant according to claim 1, wherein the first barge comprises a first hull and a second hull with a first space therebetween, wherein the first space receives a first ballast material to at least partially submerge the first barge.

8. The multipart, transportable nuclear power plant according to claim 5, wherein the first ancillary barge comprises a third hull and a fourth hull with a second space therebetween, wherein the second space receives a second ballast material to at least partially submerge the first ancillary barge.

9. The multipart, transportable nuclear power plant according to claim 6, wherein the second ancillary barge comprises a fifth hull and a sixth hull with a third space therebetween, wherein the third space receives a third ballast material to at least partially submerge the second ancillary barge.

10. The multipart, transportable nuclear power plant according to claim 1, wherein the dedicated site is a lagoon separated from the body of water by a physical barrier that may or may not allow fluid communication between the lagoon and the body of water.
